(19) United States
(12) Patent Application Publication
(10) Pub. No.: US 2015/0282518 A1
(43) Pub. Date: Oct. 8, 2015

(54) APPARATUS AND METHOD FOR HULLING FOR HARVESTED PISTACHIOS

(71) Applicant: James W. Tjerrild, Fresno, CA (US)

(72) Inventor: James W. Tjerrild, Fresno, CA (US)

(21) Appl. No.: 14/681,069

(22) Filed: Apr. 7, 2015

Related U.S. Application Data
(60) Provisional application No. 61/976,273, filed on Apr. 7, 2014.

(51) Int. Cl. A23N 5/08

(52) U.S. Cl. CPC A23N 5/08

(57) ABSTRACT

The present invention provides an apparatus for dry hulling harvested pistachios, utilizing an infeed hopper positioned adjacent an elongated rotatable drum having outer projections, wherein a first plate and a second plate are adjustably secured adjacent the drum. Adjustment of the position, angular displacement and gap space of the first plate, as well as adjustment of the gap space of the second plate, provides a configuration that may be adjusted in multiple parameters, including hulling force, dwell time and cutting force level, to optimize the hulling process to accommodate varying conditions of the pistachio product and enhance purity of the hulled product.

### CROSS REFERENCE

This application claims the benefit of U.S. Provisional Patent Application No. 61/976,273, filed on Apr. 7, 2014, which is incorporated herein in its entirety.

### BACKGROUND OF THE INVENTION

Processing of nuts which are harvested as a fruit, such as pistachios requires removal of the fruit hull in a brief window of time, and in a manner that will yield a high degree of processed nut purity. The hull of the fruit surrounding the nut must be removed soon after harvest, or there is a substantial risk of spoliation or difficulty with performing the de-hulling process as time passes. This requires a high volume of harvested product to be processed in a relatively short amount of time. This problem is magnified by the fact that there is typically a relatively brief period of time for harvesting the ripened crop, and conditions of the fruit will differ as more ripened product is introduced through the harvest time frame.

To address this need for processing a high volume of harvested product in a short amount of time, mechanical devices and processes have developed. In the example of pistachios, the objective is to remove the fruit hull that surrounds the nut shell, leaving a clean nut that may be later processed further for an eventual consumer product, whether that be in the shell or with the nut meat removed from the shell. The pistachio hull is strongly adhered to the shell, and timely removal is critical to result in a nut that is not discolored such as the result form the fruit hull not being removed immediately or is not completely removed. The objective of hulling the nut (that is, to de-hull the fruit casing of the nut) is to provide a marketable product having a straw colored nut shell, which can only be attained if done quickly after harvest. To answer this need, one traditional approach has been the use of a batch process in which the harvested product is processed in batches loaded into a chamber that has a rotating abrasive wheel at the bottom, such as is generally show in FIG. 10. In this type of device, the abrasive base rotates within the chamber and the hulls move outward by centrifugal force to an outer area of the chamber and pass through an outer opening surrounding the rotating base. As shown in FIG. 10, the dimensions of the device, typically having approximately a 36 inch diameter, severely limits the amount of harvested nuts that may be processed at a time. When the hulling process is completed, the hulled nuts are then urged outward of the chamber, such as through a door in the side of the chamber shown at the right of FIG. 10. Further, because of the limited amount of product that may be processed at a time without damaging the shell of the nuts, thus limiting a typical device to a relatively shallow height such as approximately 18 inches, the batch process of this type of a device is not a suitable process for handling the large volume of product that is typical during a short harvest season. A variation of this type of rotational drum device, utilizing the impact of fingers inside the tub for removing the hull of the pistachio, is disclosed in U.S. Pat. No. 6,941,859.

Another type of device is also typically employed in the United States to process harvested pistachios, which is a continuous feed device as shown in FIG. 11. this type of traditional processing device is akin to a vegetable peeler, having a central auger that urges product into a processing area that has a number of abrasive rollers, perhaps including secondary augers that are adjacent each abrasive roller. The harvested product enters into the processing chamber and is urged toward the abrasive rollers to remove the hulls, which fall out of the device around the circumference of the device. Because the hull of the product is merely abrasively scraped form the nuts, in some applications of this type of apparatus, a substantial amount of water is needed to wash away the fruit hull as a flush through the process. This is costly, and again risks abrasive damage to the outer shell of the nut. Further, because of the risk of over-processing the product and causing damage to the nut shell, care must be taking to adjust the proper flow rate of the product through the device, balance with the competing need for fully removing the fruit hull. Properly controlling the dwell time of product within this type of a device is therefore a challenge and must be carefully monitored throughout the process. This is a drawback of the flow-through devices such as it typically used. An example of such an apparatus is disclosed in U.S. Pat. No. 5,329,845, which utilizes abrasive bristles to remove the hull of the pistachio.

In yet another type of prior art device, used primarily in Iran, the harvested pistachios are subject to mechanical force against a plate that is positioned adjacent a rotating drum, such as is diagramed in FIG. 12. This type of device has a series of projections located on the outer surface of the drum, typically a hex head of a bolt or a series of rectangular projections welded to the drum surface. The harvested product is fed into the area adjacent the drum between two plates, one located at the top of the drum circumference, and the other at a location to the left. As the drum is rotated the product is urged toward the top plate, which has an edge of the plate to sheer away the hull from the nut and pass through a gap between the top plate and the drum. A gap is also provided between the second plate, intended to allow for passage of de-hulled product (hulled nuts) from the device. This type of device, although intended to utilize a continuous feed of operation, is limited in its usefulness and processing purity due to deficiencies (as disclosed in the publication titled “Performance evaluation of a bolt type pistachio hulling machine,” in the Journal of Agricultural Technology, 2011 Vol. 7, 57-62). In this type of a device, the top plate is positioned at a fixed location about the circumference of the drum (i.e.; it is not adjustable relative the location on the roller circumference) and therefore is not capable of adjusting important processing parameters to take into account differing ripeness of harvested product. Further, as will be evident herein, the location of the top plate is not optimal for processing pistachios.

Another drawback of this prior art device is the lack of ability to adjust other important aspects of positioning the two plates, and the lack of a proper cutting edge for efficient and sustained use of the device for extended time and through the harvest season. For example, the top plate is not substantially adjustable in its pitch (the angle of the plate relative the drum surface) to accommodate adjustable dwell time and cutting edge against the product. Also, this type of device, having fixed plates that only may be slightly adjusted in height above the drum and the angle of the top plate severely limits the ability to reliably adjust the flow of product and/or the force of an edge to remove the pistachio hull.

### SUMMARY OF THE INVENTION

The present invention relates to an apparatus and method for hulling harvested fruit, such as pistachios, for removing the hull from the nut in a rapid and reliable process with no or minimal water needed. More specifically, the present invention relates to an apparatus and process that is adjustable in a number of aspects, such that the fruit being processed to yield nuts may be hulled even as the ripeness and condition of the fruit changes during the harvest season. Aspects of the assembly, and adjustable features of the assembly and the process, effectively change the aggressiveness of the action that breaks the hull of the fruit and strip the hull from the nuts. Such adjustable aspect of the process also provides adjustable flow rate of the hulling process to optimize the production rate and hulling efficiency, while maintaining control over the level of breakage of the shells of the nuts, and still requiring very little or no water for the process. The present invention thereby provides an apparatus for hulling harvested pistachios having an infeed assembly with an infeed hopper located adjacent a moving surface that has a plurality of projections spaced about the surface. An elongated plate is positioned along an extent of the moveable surface and includes a cutter edge configured and adjustably positioned relative the surface to engage with the pistachios entering the hopper. A gap between the cutter edge and the moveable surface allows for fruit skin (hull) of the pistachio to exit the hopper such that the pistachio nut is cleaned of such fruit skin by movement of the moveable surface relative the cutter blade.

Generally, in a preferred form of the invention, the moveable surface is the outer circumferential surface of a rotatable drum, and the projections are formed as a series of optimally arranged bolt heads protruding a suitable distance above the drum surface. The cutter blade is preferably an elongated blade extending parallel the drum surface. The elongated cutter blade is in an adjustable position relative the drum surface and the uppermost surface of the projections, and is in an adjustable placement about the circumference of the drum. Further, in the preferred form, a front plate is positioned along the drum surface with an adjustable gap provided between the front plate and the drum surface to allow for pistachio nuts to exit the apparatus when the hull has been removed. Providing adjustability of the position, height and angle of the cutter blade with the cutting knife edge, along with adjustability of the front plate relative the moving surface of the rotating drum, results in an apparatus that is suitable for reliable processing of harvested pistachios in a commercial setting, which may be adjusted to accommodate differences in the size, ripeness, volume and type of products, and maintain a production speed and purity otherwise not so readily attainable. Further, the apparatus of the present invention provides reliable processing of products such as harvested pistachios in a continuous-feed mode, rather than batch processing, to minimize damage of the nut shell.

More specifically, the present invention provides an apparatus for hulling harvested pistachios having an infeed assembly with an infeed hopper that is positioned at an upper portion of the apparatus and adjacent an elongated rotatable drum. The drum has an outer surface with an outer circumference, and rotates about an elongated central axis that generally resides along a horizontal plane when the apparatus is in operational mode. The drum includes a plurality of projections along at least an extent of its outer surface, preferably rounded bolt head that protrude no more than 3 millimeters from the drum surface, and most preferably protruding in the range of 1.5 millimeters to 3 millimeters. The drum rotates in a direction toward a first elongated plate, or sometimes called the back plate, that is positioned adjacent the drum surface generally parallel the rotational axis of the drum. The first plate has a lower cutting edge with a beveled knife edge that is adjustably positioned at a gap height from the drum surface, and above the top of the projections. In the preferred embodiment, the gap between the first plate edge and the top of the projections is less than 1 millimeter, and less than 4 millimeters above the drum surface.

In a preferred embodiment, the first plate is positioned along an upper quadrant of the circumferential outer surface of the drum, below the uppermost chime of the drum and above said horizontal plane of the drum. Preferably, the position of the first (back) plate is in the range of 10° to 80° along the circumference of the drum relative the horizontal plane, and most preferably between about 30° to 60° along the circumference of the drum relative the horizontal plane. Adjustment of the first plate in this range provides a way of adjusting the applied force of product toward the cutting edge, and thereby is one way for adjusting the aggressiveness of the hulling process. Further, the first plate is adjustable in its angular displacement, such that the front surface of the plate may be angled between a positive rake angle and a negative rake angle. In the preferred embodiment, the first plate is adjustably positioned at an angular displacement to provide a rake angle from about positive 10° to about negative 15°. Along with the beveled knife edge of the first plate, adjustment of the rake angle is another important aspect of the present apparatus to provide adjustability of the aggressiveness of the cutting action for the hulling process.

The apparatus also includes a second elongated plate that is positioned adjacent the drum surface and also has an elongated axis generally parallel the rotational axis of the drum. The second plate, also called the front plate, is located in a second upper quadrant of the circumferential outer surface of the drum, opposite the area of the first plate. The second plate has a lower edge positioned adjacent the drum surface at a gap distance from the surface. The gap distance, or gap height, of the second plate from the surface is adjustable such that pistachio nuts are permitted to pass between the plate and drum surface at an adjustable rate. In a preferred embodiment, the gap between the second plate and the drum surface is adjusted to the range of between 0.8750 inch (⅞^{th} of an inch, or about 2.25 centimeters) to about 1.125 inch (1 and ⅛^{th} inch, or about 2.85 centimeters). This provides adjustability of the flow rate and the rate of extraction of hulled products for the apparatus, as the hulled nuts are allowed to pass through this gap. The distance between the first and second plate defines the width of the inner chamber where the product is subject to the hulling process. In a preferred form of the invention, the chamber width includes at least 20% of both upper quadrants of the drum circumference, and at least the first plate is adjustable in its location and thus adjustable relative the position of the second plate.

A more complete understanding of the objects, advantages, features, properties and relationships of the invention will be obtained from the following detailed description and accompanying drawings, which set forth illustrative embodiments that are indicative of the various ways in which the principles of the invention may be employed.

### BRIEF DESCRIPTION OF THE DRAWINGS

FIG. 1 is cross sectional view of a portion of the hulling apparatus according to the invention, with pistachios depicted in oversized manner (not to scale with the apparatus) and showing the pattern of movement of the product within the apparatus;

FIG. 2 is an elevated perspective view of the interior of the huller apparatus of

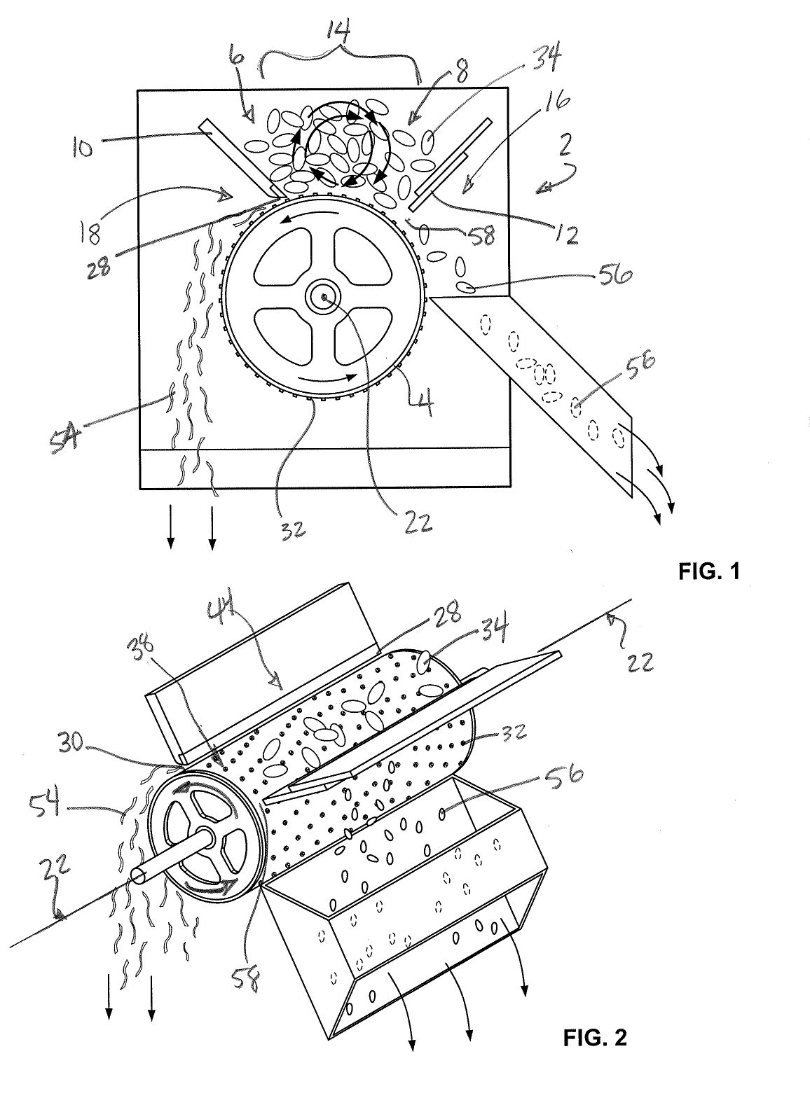

FIG. 1;

FIG. 3 is an elevated view of a drum pattern identified as a herringbone pattern of the projections in an embodiment of the apparatus;

FIG. 4 is an elevated view of a drum pattern identified as a chevron pattern of the projections in an embodiment of the apparatus;

FIG. 5 is a top plan view of the sheet stock used to form the outer surface of the drum, with apertures formed in a preferred pattern for inserting bolts to form projections on the drum surface in an embodiment of the apparatus;

FIG. 6 is a side sectional view of the cutting plate and drum of the huller apparatus shown in FIG. 1;

FIG. 7A is a an elevated plan view of the infeed hopper space with directional lines depicting the movement of pistachios within the huller apparatus of FIG. 1;

FIG. 7B is an internal view of the infeed hopper space with directional lines depicting the movement of pistachios within the huller apparatus of FIG. 1;

FIG. 7C is an elevated side view of the roller with directional lines in the area of the hopper which shows the general directional path of pistachios within the huller apparatus of FIG. 1;

FIG. 7D is a side view of the components of the assembly of FIG. 1 (viewed from the opposite end to that if FIG. 1) with arrow lines depicting the movement of pistachios within the huller apparatus;

FIG. 8 is a side view showing the adjustable range of position of the front and back plate relative the drum in the apparatus of FIG. 1;

FIG. 9A is a side sectional diagram showing the position of the back plate relative the drum when the apparatus of FIG. 1 is adjusted to a particular configuration as shown;

FIG. 9B is a side sectional view representing the position of the back plate relative the drum when the apparatus of FIG. 1 is adjusted to the configuration as shown;

FIG. 9C is a side sectional view representing the position of the back plate relative the drum when the apparatus of FIG. 1 is adjusted to the configuration as shown;

FIG. 10 is a side sectional view of a conventional or prior art device using an abrasive bottom on a circular container which uses substantial water for hulling;

FIG. 11 is a side sectional view of a conventional or prior art device using a cage of grit rollers and a central auger, also a device which uses substantial water for hulling.

FIG. 12 is a side sectional view of a device that is believed to be in practice outside the United States utilizing a roller with projections and a top plate locate at the upper chime of the roller and a lower plate located at a distance from the top plate.

### DETAILED DESCRIPTION OF THE DRAWINGS

The description that follows describes, illustrates and exemplifies one or more embodiment of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that may come to mind in accordance with these principles. The scope of the invention is intended to cover all such embodiments that may fall within the scope of the appended claims, either literally or under the doctrine of equivalents.

The apparatus 2 of the present invention is generally made up of a rotating cylindrical drum 4 positioned below an in-feed hopper 6 having an inner chamber 8 located between an elongated first plate 10 and a second plate 12. The first plate 10 and second plate 12 are preferably generally in parallel arrangement with one another, each extending along the length of the rotatable drum 4, and preferably spaced apart at an adjustable distance 14 relative one another. The second plate (the “front plate”) 12 is located along an upper quadrant 16 of the drum 4 such that the surface of the drum 4 rotates away from the front plate 12. The back plate 10 is located at an upper quadrant 18 of the circumferential surface of the rotating drum, such that the rotation is toward the back plate. In this arrangement, the back plate 10 is positioned within the respective upper quadrant 18 of the drum 4 such that the drum surface moves downward from the uppermost point of the outer periphery of the cylindrical drum (referenced herein as the top or “chime” 20 of the drum 4) when in operational position, with the elongated axis 22 of the drum 4 generally parallel a horizontal plane 24. As shown in the Figures and explained herein, the back plate 10 position and relative angle of displacement 26 from the circumferential surface of the drum 4 is adjustable. Further, the back plate 10 has a lower edge 28 formed as a cutter edge, preferably as a replaceable cutting edge that may be replaced or repaired, having a lower edge 28 that is spaced from the drum surface at an adjustable gap 30.

A significant aspect of the function of the blade in this apparatus is providing a bottom cutting edge 28 that is positioned at an angle relative the directional force on the product from the rotation of the drum 4. In a preferred embodiment, as shown in the Figures, the drum 4 urges the product in a directional force along a path that is not directly perpendicular to the elongated edge of the knife, and instead is at an oblique angle relative the cutting edge.

In the example shown, the drum 4 has a plurality of projections 32 arranged in a pattern, generally a herringbone pattern or a chevron pattern as shown in FIGS. 3 and 4, such that, when the drum 4 is rotated, the projections 32 come into contact with the product 34 (un-hulled product) to apply a force on the product wherein the direction of the force is not directly perpendicular to the elongated edge 28 serving as a knife edge. In other words, the projections 32 are arranged on the circumferential surface of the rotating drum 4 in a herringbone or chevron pattern such that rotation of the drum 4 causes the projections 32 to contact and force of the bulk of the product 34 in a direction that is at an angle relative the elongated cutting edge 28 of the back plate 10.

More specifically, the arrangement of projections 32 on the drum 4 results in an applied force against the product in the quadrant 18 of the circumferential surface of the drum 4, located below the top chime of the drum and extending downward toward the back plate 10 (i.e., the downward quadrant 18 of the drum surface shown in the Figures. As the drum 4 is rotated, this arrangement of the projections 32 results in continuous waves of force of the projections 32 in the angular orientation. The resulting angular directional force applied against the product (i.e., angular relative the elongated cutting edge of the back plate) generally drives the product to approach the cutting edge of the back plate 10 at an angle that is more efficient than achieved if the product was forced directly perpendicular the elongated cutting edge. In this manner, the arrangement of the projections 32 and rotation of the drum 4 urges the product 34 into a sheer angle against the cutting edge, wherein the sheer angle is oblique, generally directed along an extent of the length of the elongated cutting edge.

In the apparatus shown and described, it is preferred that the projections 32 are arranged in a pattern on the outer surface of the drum 4 in a herringbone or chevron arrangement such as shown in FIGS. 3-5 FIG. 5 showing the pattern of drilled holes 36 used for creating the pattern, such that rounded-head bolts are screwed into the drilled holes 36 to provide the pattern desired for the projections 32). With this arrangement, when the drum 4 is rotated, the outermost projections 38 of the pattern (those at the edges of the drum) define the lead positions of the rotating projections 32. In this arrangement of projections 32 and rotational direction of the drum, the product at the surface 40 of the drum 4 is repeatedly urged toward the central region 44 of the drum 4 and toward the back plate. The product then strikes the chisel surface of the cutting edge 28 of the back plate 10, which cuts away the hull 54 of the product 34 as the product 34 is engaged along the cutting edge 28. As the cut away hull 54 is allowed to pass through a small gap 58 under the back plate 10, the remaining product 34 is then forced against the upper portion of the back plate 10 and is lifted above the surface of the drum 4 by the angular position of the upper portion of the back plate, as is best shown in FIGS. 7C and 7D. This directional movement of the product within the chamber causes a vortex of movement 42 of the product 34 at the back plate 10, resulting in the product 34 to tumble generally away from the central region 44 of the drum 4 due a bulk of product 34 forming an increased bed depth in the central region 44 closer to the drum surface, as shown in FIGS. 7A and 7B.

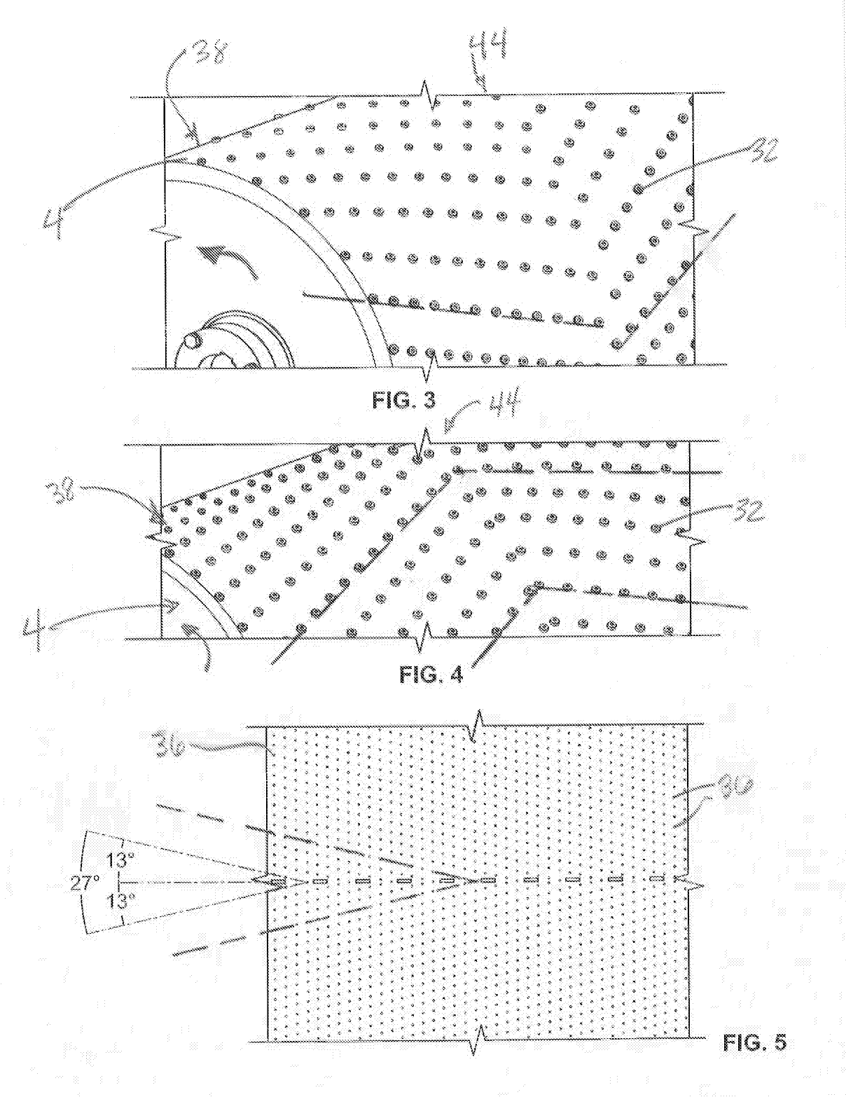

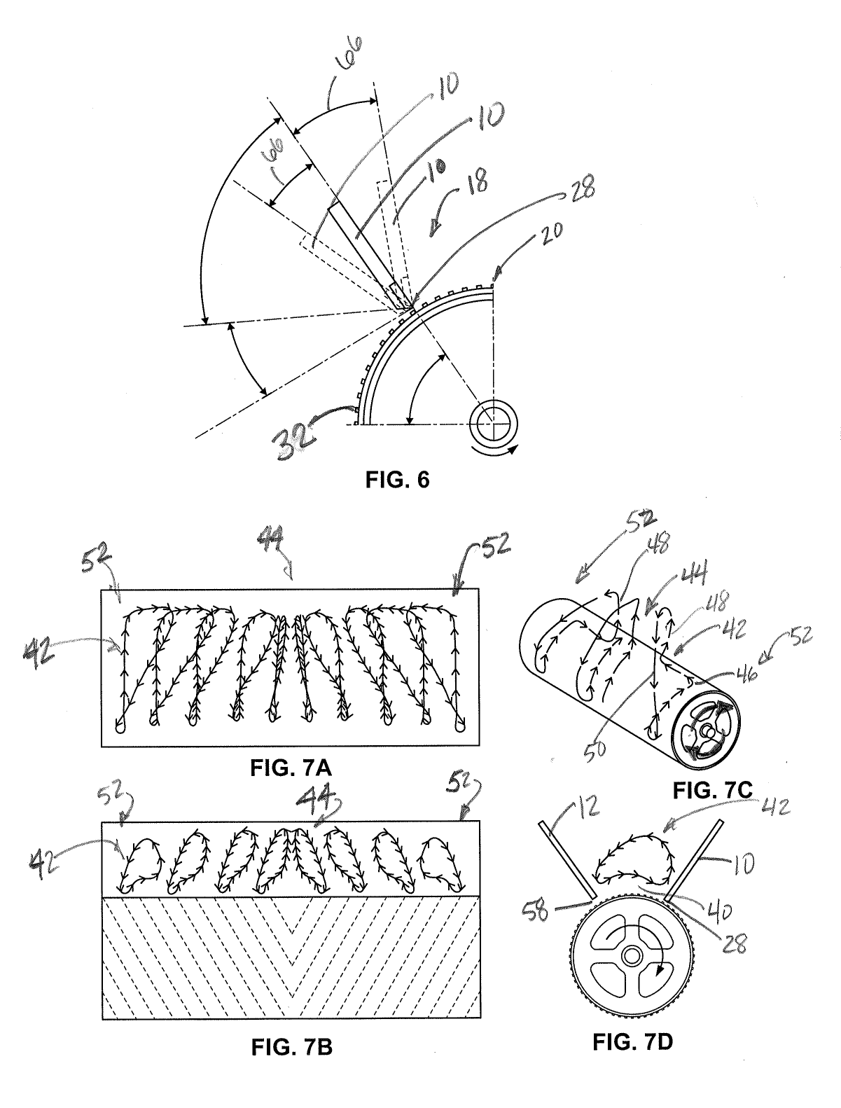

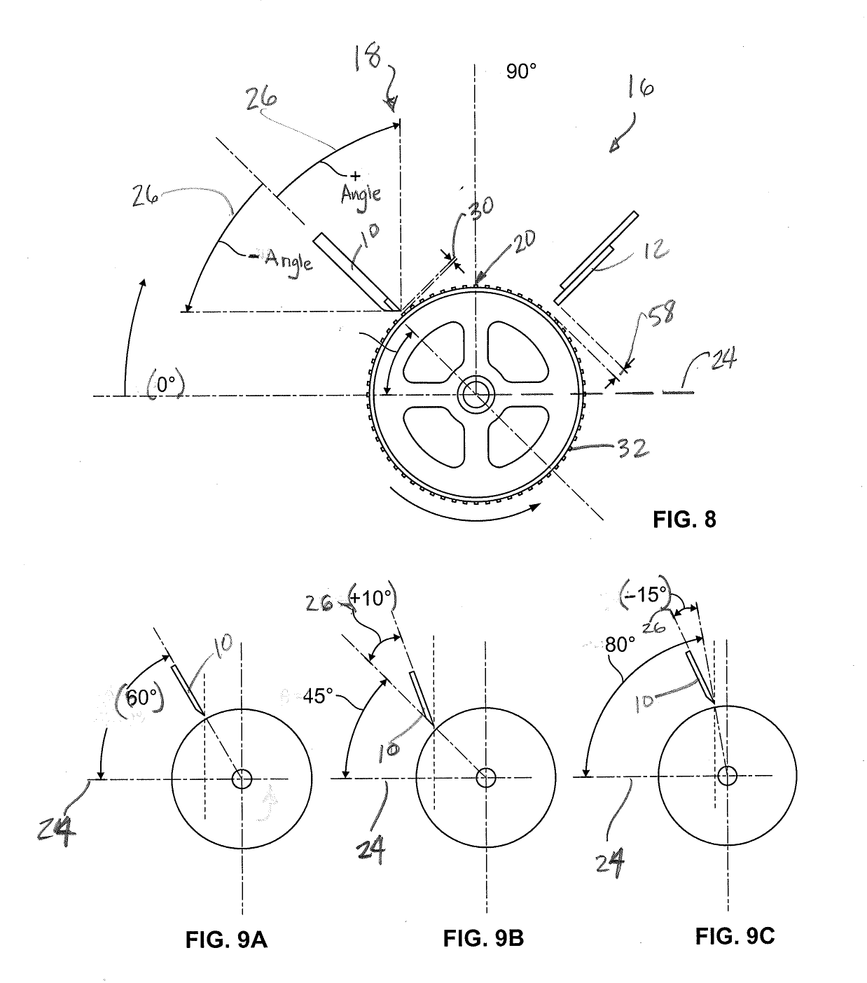

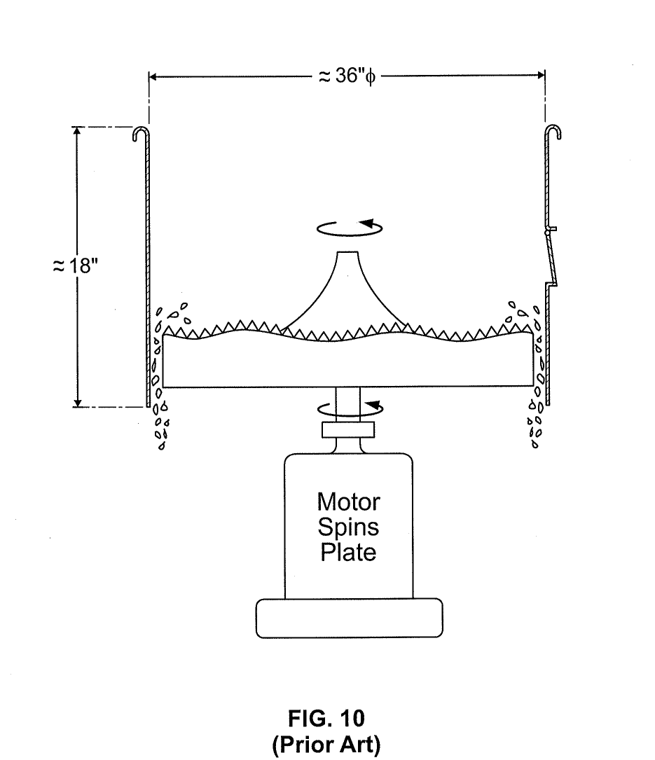

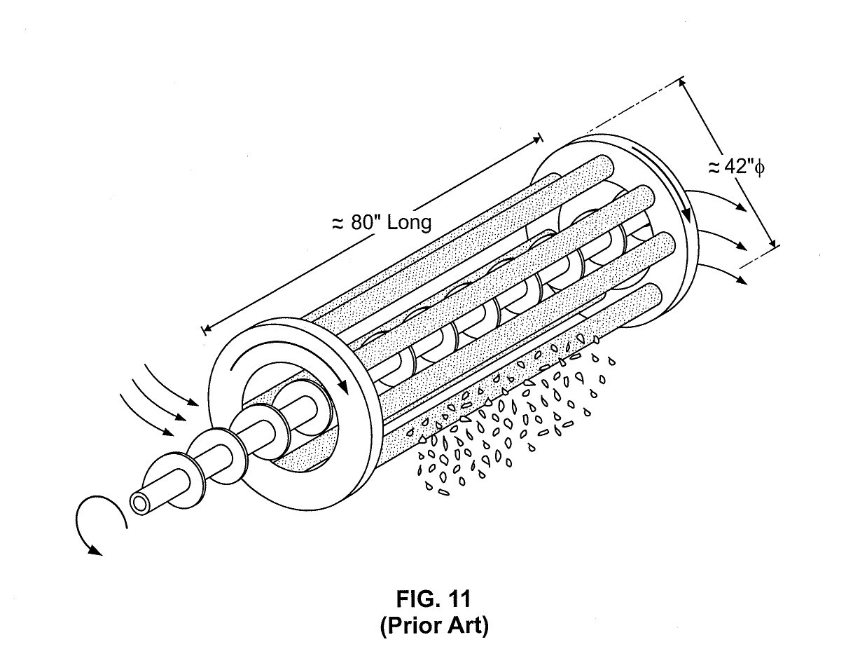

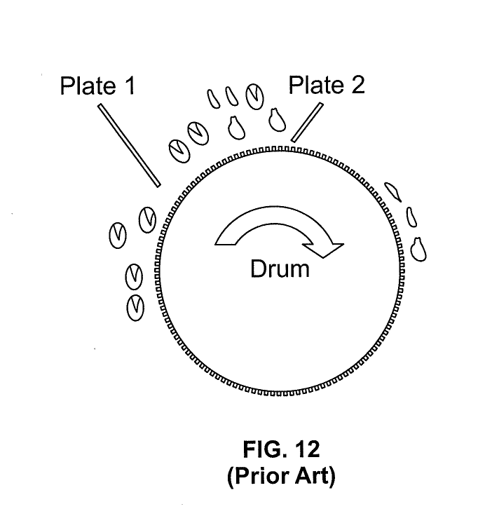

As the process continues by rotation of the drum, the product continues into a cycle of this movement—product 34 being mechanically forced at an oblique shear angle 46 against the cutting edge 28, rising upward 48 in a path generally along the plate surface above the cutting edge 28 and tumbling down 50 in a path generally toward the opposite plate at an angle generally toward the sides 52 of the drum 4. When the hull 54 has been fully stripped from the nut 56 (the hulling operation on the harvested product 34 is complete), the nut 56 tends to tumble further away from the back plate 10 and the vortex 42 of product 34 adjacent the back plate 10, to thereby passes into the other upper quadrant 18 of the rotating drum 4 where it continues to tumble against the front plate 12 and eventually pass through a predetermined gap 58 between the drum 4 surface and the front plate 12. This cycle of the product 34 being processed within the chamber 8 in a tumbling motion, being forced against the cutting edge 28 of the back plate 10 to strip away the fruit hull 54, and wherein the hulled product 56 tumbles toward the front plate 12 to pass under the front plate 12 gap, is best shown in FIGS. 1 and 2.

In the preferred embodiment for processing an appropriate amount of product 34 in a continuous feed apparatus, the drum 4 has a length of approximately 48 inches and a diameter of about 20 inches. Within the outer surface of the drum 4 with such dimensions, there are more than 1000 small projections, preferably about 1240 projections. In the preferred form of the invention, the projections 32 are created by threaded tapping or drilling holes 36 in the outer surface of the drum 4 and inserting threaded bolts that have specific shape and size. Accordingly, the holes 36 are formed in the steel circumferential surface, and the projections 34 are formed by inserting bolts that are approximately 1 inch length and have a rounded low profile head, preferably a low profile steel socket head cap screw type fastener with a head height no greater than ⅛ inch (0.125 inch), or approximately 3 millimeters. In a preferred form of the invention, the bolt heads are preferably 2 millimeters or 1.5 millimeters in height. The use of rounded head bolts has been found to provide sufficient mechanical force to move the harvested product 34 within the chamber 8 and yet not cause abuse or damage of the product, such as damage to the shell casing of the nut 56 that may result from a hex-head bolt. Further, the rounded shape of the projections provides longevity of the bolt head in use, particularly if the bolt is a socket type head such as it may be extracted with an Allen wrench after being worn by product and debris that is accidentally mixed in the product 34 during operation of the apparatus.

The back plate 10 has an elongated length that spans the length of the outer surface of the drum. The back plate 10 is preferable formed of steel with a sturdy construction (such as with a thickness of approximately 3/16 inch (0.1875 inch). The cutting edge 28 of the back plate 10 is preferable a removable segment that has a lower edge with a bevel, preferable as a chisel knife with a knife angle in the range of 60° to 80° (i.e., a relief angle in the range of 10° to 20°), and preferable approximately 75° (i.e., a relief angle of 15°). This results in a lead edge of the back plate 10 being a replaceable cutting edge, and provides a knife angle that resists becoming dull quickly when in harsh contact with the product or foreign debris such as rocks and sticks.

In the preferred embodiment, the back plate 10 has an adjustable position and orientation relative to the drum surface. More specifically, the back plate 10 is configured to be moved with a range of positions along the outer circumference of the drum. Generally, the back plate 10 range of positioning resides within the same upper quadrant 18 of the drum, i.e., the position of the lead edge of the back plate 10 may vary within the area below the top chime 20 of the drum surface and a horizontal cross section through the drum 4. This is one distinct advantage over the prior art type of devices shown in FIG. 12. The back plate 10 is not only optimally located radially downward from the chime of the roller (unlike with the prior art of FIG. 12), but also the position of the back plate 10 relative the circumference of the drum 4 is adjustable to provide variation to critical aspects of the process, thereby accommodating differing conditions of the product and the process speed. This adjustment further is a primary adjustment of the extent of the chamber 8 for processing the product 34.

It is preferable for the apparatus to have a back plate 10 that may be adjusted such that the cutting edge 28 is positioned between about 10° to about 80° from the horizontal line (i.e., in the range of about 10° to about 80° below the upper chime 20 of the round drum). The optimal range of the cutting edge 28 position in an apparatus dimensioned as described herein is between about 30° and about 60° upward from the horizontal cross sectional line of the cylindrical drum diameter (thus between about 30°-60° below the upper chime 20 of the drum 4). This aspect of the invention, providing adjustable positioning of the back plate 10 about the drum circumference, is significant in providing a means for adjusting the applied force of the product 34 toward the cutting blade edge 28. For example, with the apparatus described, more than 1,200 low profile projections 32 are applying force on the bed of product 34 within the chamber 8, due to the drum 4 rotating approximately 250 rpm (with a drum surface rim speed of about 1,300 feet/minute). When the back plate 10 is moved lower along the circumference of the drum, such as being moved from the 80° position (FIG. 9C) to the 45° position (FIG. 9B), gravity force on the product 34 is increased and magnifies the force at which the product 34 is urged toward the cutting edge 28.

Such magnification (or reduction, when moving the back plate 10 upward from the horizontal line and toward the chime 20 of the drum 4) thereby provides adjustment of the forced interaction of the cutting edge on the product. Such adjustment of the back plate 10 positioning about the drum circumference also provides adjustment of the dwell time of the product within the chamber 8—the time in which product is processed by cycling within the chamber 8 prior to residing primarily against the front plate 12 and exiting below the front plate gap 58. When the back plate 10 edge is further from the horizontal cross sectional line and closer to the drum chime 20, there is less room for the product 34 to be pulled into the tumbling vortex approaching the back plate 10, and the product is located closer to the front plate 12 where it eventually exists the apparatus. Thus, adjustment of the location of the back plate 10 within an upper quadrant 18 of the drum circumference provides adjustability of the cutting force against the cutting edge and adjustability of the flow rate and dwell time of the product being processed. This aspect of the invention, in combination with other adjustable aspects of the back plate 10 and a cutting edge with a rake angle as described herein, provides variable parameters of the process that is unique and resolves problems with prior art devices such as shown in FIGS. 10-12. Further, these variable aspects of the apparatus of the present invention allows for operation of the process with optimized force, scalable aggressiveness of the cutting action against the cutting edge, and variable run speed to adjust dwell time, so the hulling process may be efficiently performed on a variety of products with differing characteristics such as nut size, ripeness of the product and varying “stickiness” of the hull to the nut shell.

In the preferred embodiment, the drum 4 is rotated in the range of 240-260 revolutions per minute (rpm), driven by a 5 horse power motor with a belt and pulley drive assembly. The resulting optimal range of operating the assembly line described has rim speed approximately 1250-1370 feet per minute. The lead edge, the cutting edge 28, of the back plate 10 resides less than 4 millimeters above the drum surface, providing a clearance of 1.0 mm above the low profile projections (when using 3.0 mm bolt heads). Preferably, this gap is no more than 3 millimeters above the surface of the drum 4 when smaller projections are used, such as bolts with a head height of about 2 millimeters. The gap between the cutting edge and the drum surface allows the hulls 54 of the product 34 to pass through and exit the apparatus, yet the nuts do not pass through and cannot wedge into the gap space.

The back plate 10 also is adjustable in its angular orientation relative to the drum surface. This may be defined as a variable rake angle 66 of the back plate. The rake angle, as shown, is either at normal (the back plate 10 generally resides along a circumferential line through the drum), or it may be a negative rake or a positive rake angle. The negative rake angle is the result of the lead (cutting) edge trailing the upper portion of the back plate. Essentially this is the configuration in which the back plate axis 68 is at an acute angle relative a tangent line of the drum surface. Conversely, a positive rake angle exists when the upper portion 70 of the back plate 10 trails the lower cutting edge. Essentially, this is the configuration in which the axis of the back plate 68 is at an obtuse angle relative a tangent line of the surface at the cutting edge 28.

Adjustment of the rake angle 66 is useful as a means for changing the cutting force of the edge 28 against the product 34. An assembly having a negative rake angle 66 will exhibit increased cutting force against the product 34. This may be partially useful when processing pistachios harvested early in the harvest season, when the fruit is not fully ripe for easily removing the hull 54. Conversely, when the back plate 10 is configured with a positive rake angle 66, the cutting force is lower and less aggressive against the product.

It has been found that, when processing pistachios, having a negative rake angle (less than 90° from a tangent line) provides a cutting force that is aggressive, which may result in undesired breakage or chipping of the shell. Therefore, adjustment of the rake angle 66 is a significant means for adjusting the cutting force on the product, along with the back plate 10 position adjustment. This provides significant adjustment to control the process of pistachios during the harvest season. In California for example, the ideal harvest season ranges from September 1 to 28, with the pistachios being in optimal ripeness around September 15. Early in the harvest season, the pistachios have a hull not fully ripe and somewhat difficult to cut away. Late in the harvest season, the pistachios are somewhat overly ripe, which causes the hull to be sticky when being cut away and removed.

The process described herein is surprisingly efficient without the need for water such as is required with existing methods for processing pistachios. For example, common methods and equipment in use for processing pistachio nuts require approximately ½ gallon of water to yield one pound of pistachio nuts, or 42,000 gallons for 8,000 pounds of product. The process and apparatus described also has an added superior feature of not resulting in sticks or debris being collected in the finished nut collection hopper, primarily because the height of the front plate 12 may be kept at a relatively small gap space. Further, the process and the apparatus described herein provides superior adjustability of components to optimize production efficiency and accommodate varying types of products such as variations of pistachios, as well provide adjustability for ripeness of the product and the resulting variation of the hull softness and stickiness in adhering to the nut shell.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. An apparatus for hulling harvested pistachios comprising;
an infeed assembly comprising an infeed hopper positioned at an upper portion of the apparatus, the infeed hopper having an inner chamber,
an elongated rotatable drum positioned within the apparatus, said drum having an outer surface with an outer circumference, and said drum having an elongated axis of rotation generally residing along a horizontal plane, wherein said drum is rotatable about the axis in a rotational direction,
said drum further comprising a plurality of projections on said outer surface along at least an extent of an elongated length of the drum;
a first elongated plate positioned adjacent the drum surface generally parallel said rotational axis of the drum, the first plate having a lower cutting edge and a generally flat front face positioned at an adjustable angular displacement relative the drum surface, said first plate further having an adjustable height above the drum surface to define a gap space of the first plate.

2. The apparatus of claim 1, wherein;
said first plate is positioned along an upper quadrant of the circumferential outer surface of the drum, said position of the first plate being below the uppermost chime of the drum and above said horizontal plane of the drum.

3. The apparatus of claim 2 wherein;
the position of the first plate relative the horizontal line of the drum is in the range of 10° to 80° along the circumference of the drum relative the horizontal plane.

4. The apparatus of claim 3 wherein;
the first plate is positioned between about 30° to 60° along the circumference of the drum relative the horizontal plane.

5. The apparatus of claim 2 wherein;
the position of the first plate is adjustable to provide a means for adjusting the applied force of product toward the cutting edge.

6. The apparatus of claim 5 wherein;
the means for adjusting the applied force includes adjusting the position of the first plate between about 30° to 60° along the circumference of the drum relative the horizontal plane.

7. The apparatus of claim 2 wherein;
the first plate is adjustably positioned at a rake angle relative the drum, said first plate having an adjustable configuration between a positive rake angle and a negative rake angle.

8. The apparatus of claim 2 further comprising a second elongated plate positioned adjacent the drum surface and wherein;
a second elongated plate is positioned adjacent the drum surface and has an elongated axis that is generally parallel said rotational axis of the drum, said second elongated plate is located in a second upper quadrant of the circumferential outer surface of the drum, and has a lower edge adjacent the drum surface at a gap, said gap height of the second plate being adjustable such that pistachio nuts are permitted to pass between the plate and drum surface at an adjustable rate.

9. The apparatus of claim 8, wherein;
the projections are comprised of rounded bolt head protruding from the outer surface of the drum at an overall height of 3 millimeters or less.

10. The apparatus of claim 8, wherein;
said gap between the lower edge of the first plate and the drum surface is adjustable to less than 1 mm above the upper surface of the plurality of projections.

11. The apparatus of claim 8, wherein;
the first plate is adjustably positioned at an angular displacement to provide a rake angle from about positive 10° to about negative 15°.

12. The apparatus of claim 8, wherein;
the lower cutting edge of the first plate comprising a beveled edge with a knife angle.

13. The apparatus of claim 8, wherein;
the gap height of said first plate being less than 4 mm above the drum surface, and the position of the first plate relative the horizontal line of the drum is greater than 30° along the circumference of the drum relative the horizontal plane.

14. An apparatus for hulling harvested pistachios comprising:
an infeed assembly comprising an in-feed hopper positioned at an upper portion of the apparatus,
a rotating drum assembly positioned within the apparatus, said drum having a generally round cutter circumferential surface and an elongated axis of rotation that lies generally along a horizontal plane and a rotational direction,
said drum further comprising a plurality of projection on said outer surface;
a first elongated plate positioned adjacent the drum surface and having a length extending along an axis generally parallel said rotational axis of the drum.
a second elongated plate is positioned adjacent the drum surface and has a length extending along an axis that is generally parallel said rotational axis of the drum, said second elongated plate being spaced apart from said first plate at a distance defining an inner chamber width extending between the upper quadrants of the circumference of the drum;
said inner chamber width is adjustable by movement of said distance between the first and second plates.

15. The apparatus of claim 14, wherein;
the first plate is positioned in the range of 30° to 60° about the outer circumferential surface relative a horizontal cross-section of the drum.

16. the apparatus of claim 15, wherein;
the drum circumference has an upper chime and two upper quadrants between the chime and a horizontal cross section of the drum, and wherein the chamber width includes at least 20% of both upper quadrants of the drum circumference.

17. The apparatus of claim 15, wherein;
the first plate has an adjustable range of position about the outer circumferential surface and has an adjustable angular displacement relative the drum surface.

18. The apparatus of claim 17, wherein;
the first plate has a lower cutting blade formed as a beveled edge and said angular displacement of the first plate is configured to adjust a rake angle of the beveled edge.

19. The apparatus of claim 18, wherein;
the rake angle is adjustable between a positive rake angle and a negative rake angle.

20. The apparatus of claim 17, wherein;
the first plate has an adjustable height above said drum surface to provide an adjustable gap space between the plate and said drum surface.

21. The apparatus of claim 17, wherein;
the projections on said drum surface are rounded bolt heads that are about 3 mm or less in height.

22. The apparatus of claim 21, wherein;
the gap between the first plate and the drum surface is adjustable to less than 1 mm above the upper surface of the plurality of projections.

23. The apparatus of claim 20, wherein;
the angular displacement of the first plate is configured to provide a rake angle at from about positive 10° to about negative 15° and a lower edge of the first plate has a beveled edge with a knife angle;
said adjustment height of said first plate being capable of providing a gap less than 4 mm above the drum surface, and wherein said adjustable position of the first plate being greater than about 45° from a horizontal cross section line of the drum circumference.
